(19) United States
(12) Patent Application Publication
(10) Pub. No.: US 2012/0008088 A1
(43) Pub. Date: Jan. 12, 2012

(54) 3D Glasses

(76) Inventor: John Ching Shieh, Zhongli City (TW)

(21) Appl. No.: 12/832,190

(22) Filed: Jul. 8, 2010

(51) Int. Cl. G02C 11/00

(52) U.S. Cl. 351/158

(57) ABSTRACT

A pair of 3D glasses includes an eyeglass frame having left and right rims, a LCD mounted in each of the left and right rims, and left and right myopia lenses respectively mounted in a mounting groove in each of the left and right rims and kept right behind the LCDs, and an adjustment structure that allows adjustment of the pitch between the left and right rims.

### BACKGROUND OF THE INVENTION

1. Field of the Invention

The present invention relates to a pair of 3D glasses for 3D TV, 3D projector, 3D movie and 3D PC monitor, and more particularly, to such a 3D glasses, which allows detachable installation of left and right myopia lenses in the left and right rims of the eyeglasses frame so that the user can wear the pair of 3D glasses to watch a 3D TV, 3D projector, 3D movie and 3D PC monitor program comfortably without using his (her) short-sighted glasses.

2. Description of the Related Art

Following fast development of modern technology, the visual effects of regular TVs can no longer meet consumer satisfaction. Therefore, 3D TVs, 3D projector, 3D movie and 3D PC monitor capable of providing 3D visual effects have become more and more invited by consumers. However, it is necessary to wear a pair of 3D glasses when watching a 3D TV, 3D projector, 3D movie and 3D PC monitor program. If one is wearing a pair of myopia lenses, attaching a pair of 3D glasses to the pair of myopia lenses for watching a 3D TV, 3D projector, 3D movie and 3D PC monitor program will cause the user to feel uncomfortable

Therefore, it is desirable to provide a pair of 3D glasses for 3D TV, 3D projector, 3D movie and 3D PC monitor which eliminates the aforesaid problem.

### SUMMARY OF THE INVENTION

The present invention has been accomplished to provide a pair of 3D glasses for 3D TV, 3D projector, 3D movie, 3D PC monitor, which eliminates the drawbacks of the aforesaid prior art design.

It is therefore the main object of the present invention to provide a pair of 3D glasses for 3D TV, 3D projector, 3D movie and 3D PC monitor which has a mounting groove formed in each of the left and right rims of the eyeglass frame thereof so that a user can insert left and right myopia lenses in the mounting grooves of the left and right rims. Thus, the user can wear the pair of 3D glasses to watch a 3D TV, 3D projector, 3D movie and 3D PC monitor program comfortably without using his (her) short-sighted glasses.

It is another object of the present invention to provide a pair of 3D glasses for 3D TV, 3D projector, 3D movie and 3D PC monitor which allows replacement of the loaded myopia lenses subject to the degrees of short sight of the user's left and right eyes.

It is still another object of the present invention to provide a pair of 3D glasses for 3D TV, 3D projector, 3D movie and 3D PC monitor which allows adjustment of the pitch between the left and right rims so that the myopia lenses can fit the user's eyes accurately and comfortably when watching a 3D TV, 3D projector, 3D movie and 3D PC monitor program.

It is still another object of the present invention to provide a pair of 3D glasses for 3D TV, 3D projector, 3D movie and 3D PC monitor which facilitates quick adjustment of the pitch between the left and right rims so that the myopia lenses

### BRIEF DESCRIPTION OF THE DRAWING

FIG. 1 is an exploded view of 3D eyeglasses for 3D TV, 3D projector, 3D movie and 3D PC monitor in accordance with a first embodiment of the present invention.

FIG. 2 is an exploded view in an enlarged scale of a part of FIG. 1, showing the relation ship between the left rim of the eyeglass frame and the left myopia lens.

FIG. 3 is an elevational assembly view of the 3D eyeglasses for 3D TV, 3D projector, 3D movie and 3D PC monitor in accordance with the first embodiment of the present invention.

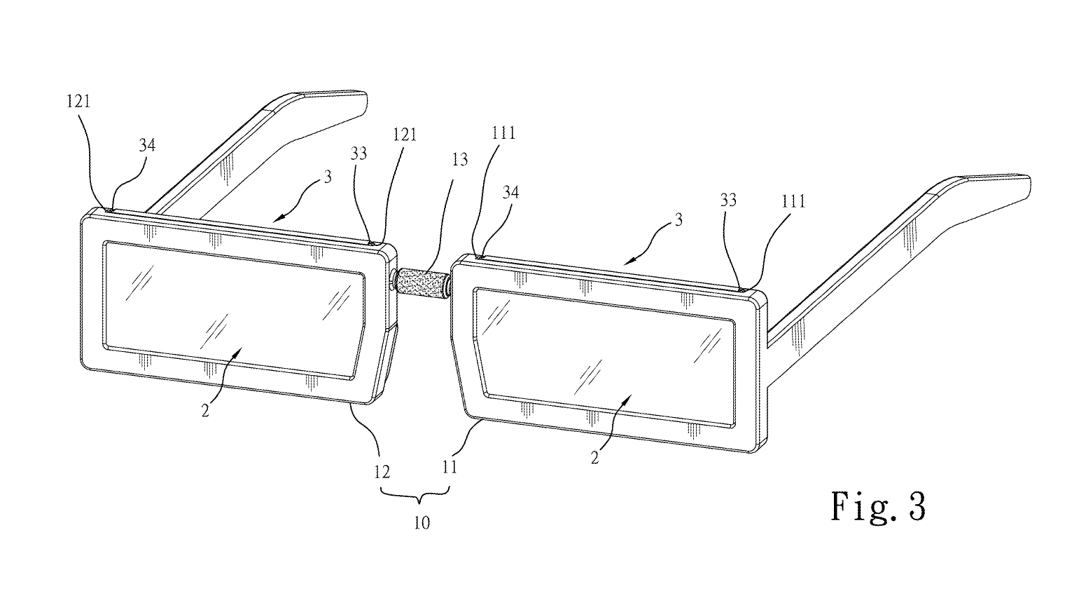

FIG. 4 is an enlarged view of a part of FIG. 1, showing the right myopia lens installed in the right rim of the eyeglass frame.

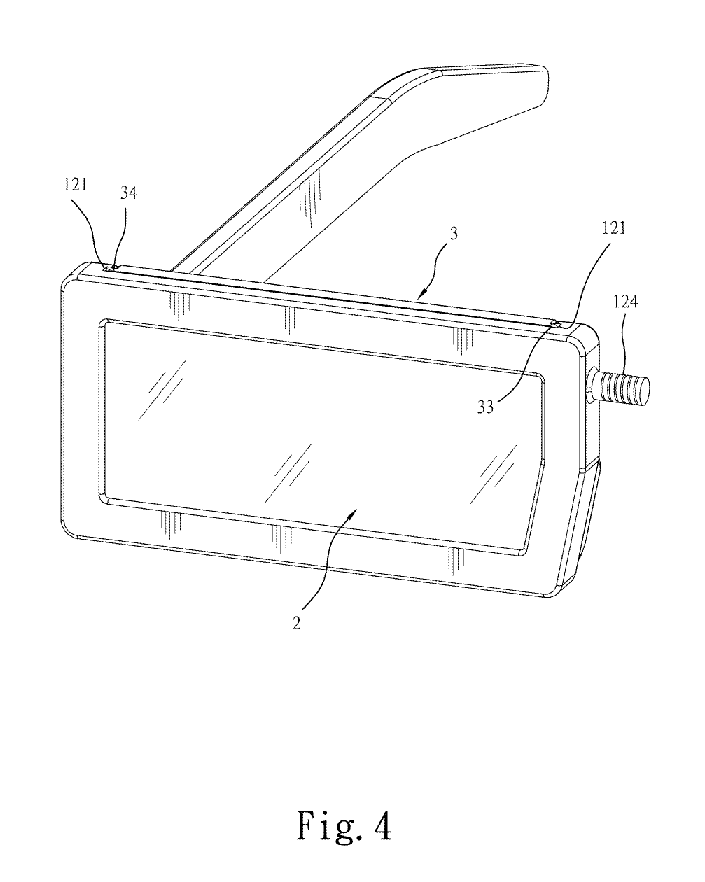

FIG. 5 corresponds to FIG. 1 when viewed from another angle.

FIG. 6 corresponds to FIG. 2 when viewed from another angle.

FIG. 7 corresponds to FIG. 3 when viewed from another angle.

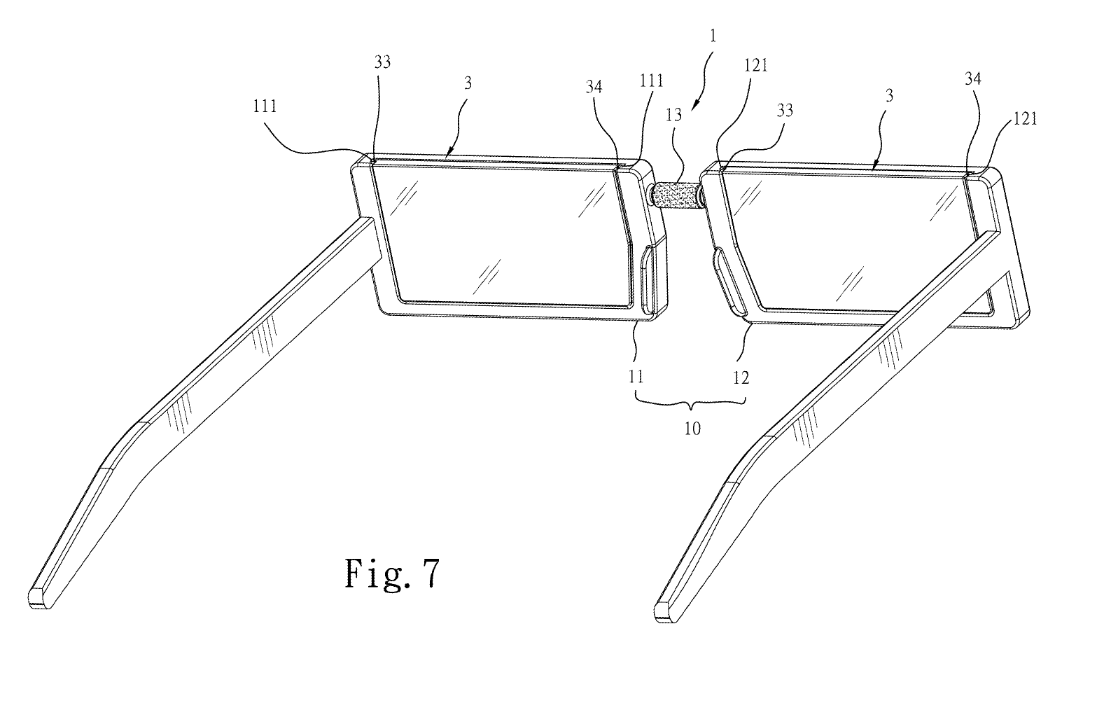

FIG. 8 corresponds to FIG. 4 when viewed from another angle.

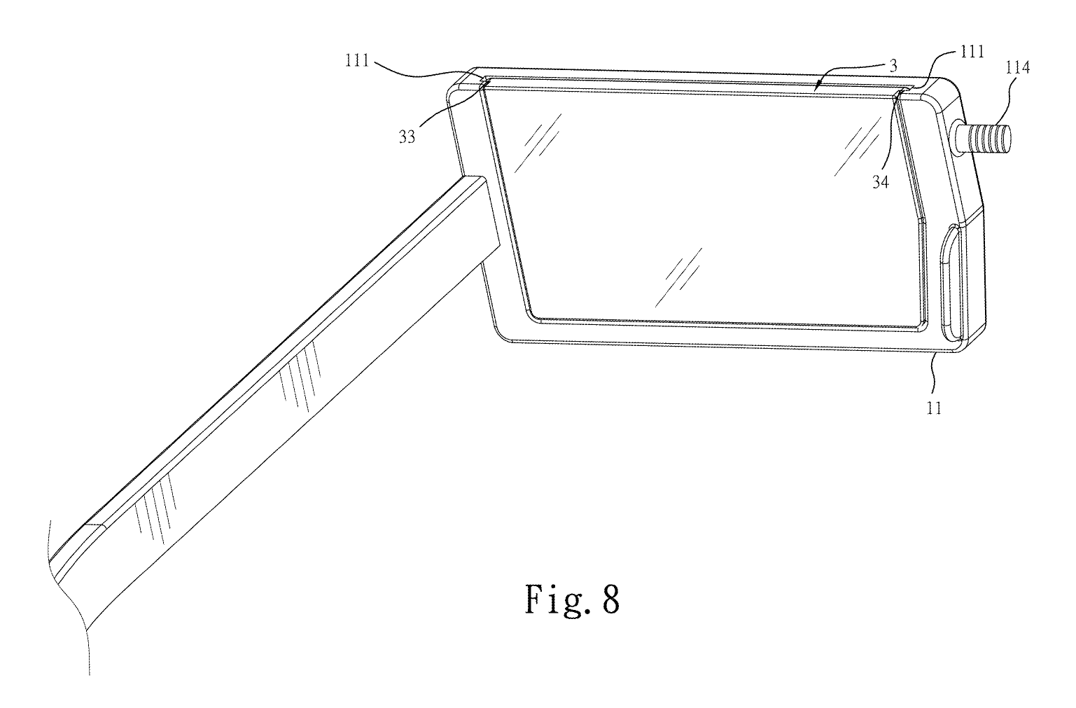

FIG. 9 is an exploded view of 3D eyeglasses for 3D TV, 3D projector, 3D movie and 3D PC monitor in accordance with a second embodiment of the present invention.

FIG. 10 is an exploded view in an enlarged scale of a part of FIG. 9, showing the relation ship between the left rim of the eyeglass frame and the left myopia lens.

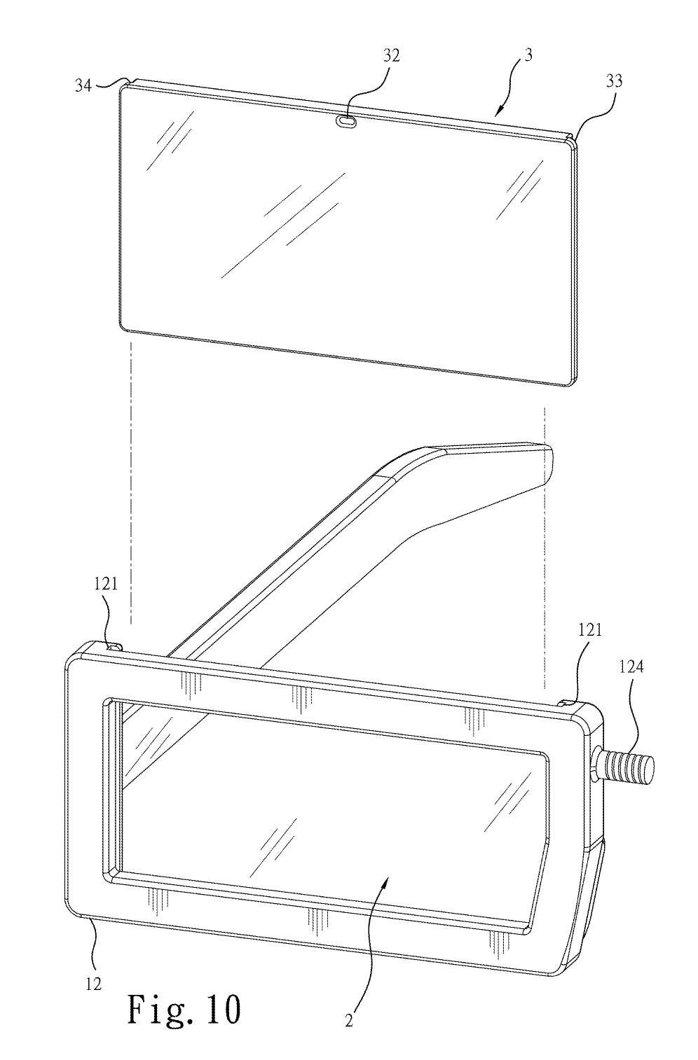

FIG. 11 corresponds to FIG. 9 when viewed from another angle.

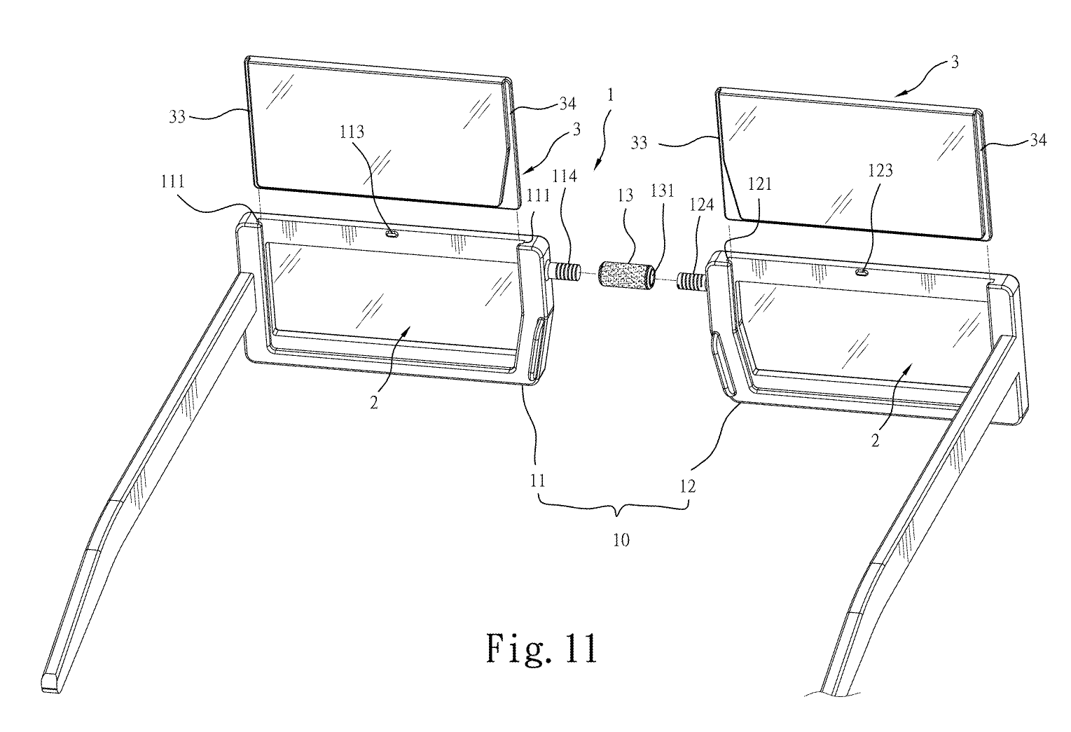

FIG. 12 corresponds to FIG. 10 when viewed from another angle.

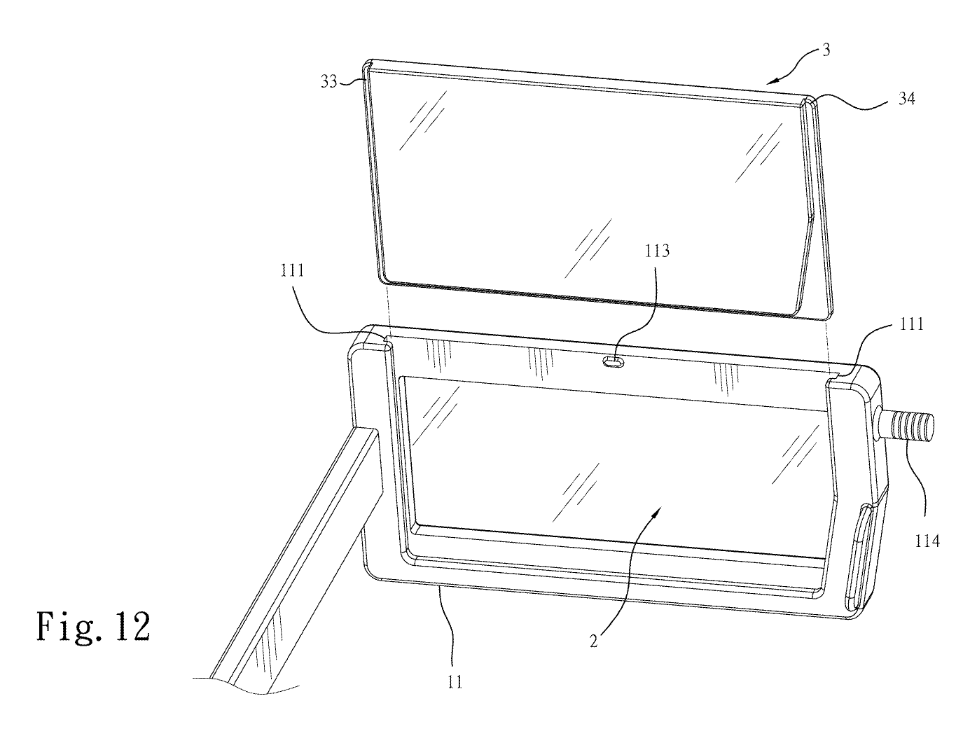

FIG. 13 is an exploded partial view of 3D eyeglasses for 3D TV, 3D projector, 3D movie and 3D PC monitor in accordance with a third embodiment of the present invention.

FIG. 14 is an enlarged view of a part of FIG. 14, showing the details of the adjustment structure.

FIG. 15 is an assembly view in an enlarged scale of FIG. 13.

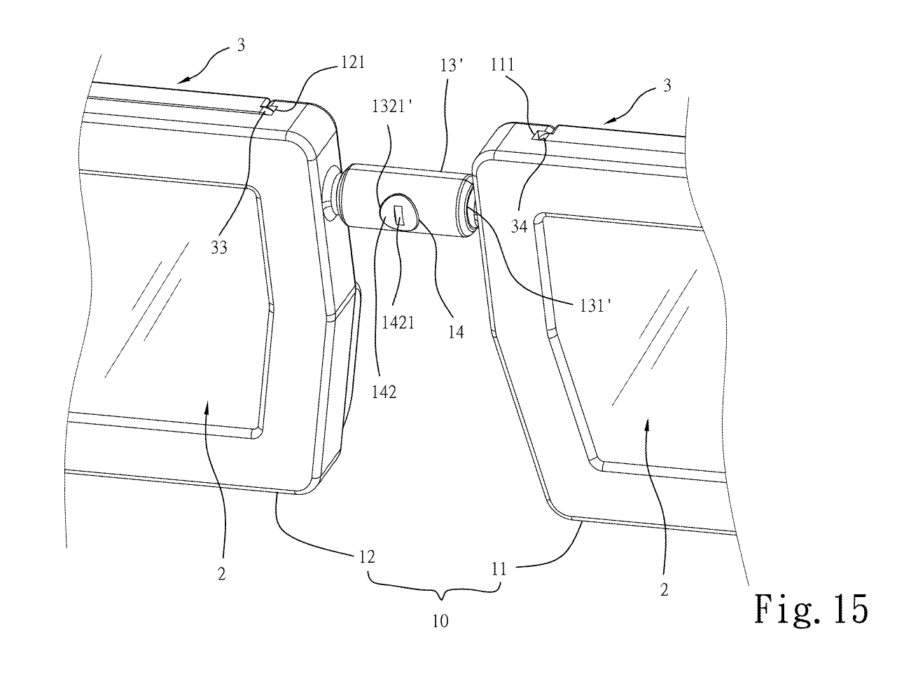

FIG. 16 is an elevational assembly view of the 3D eyeglasses for 3D TV, 3D projector, 3D movie and 3D PC monitor in accordance with the third embodiment of the present invention.

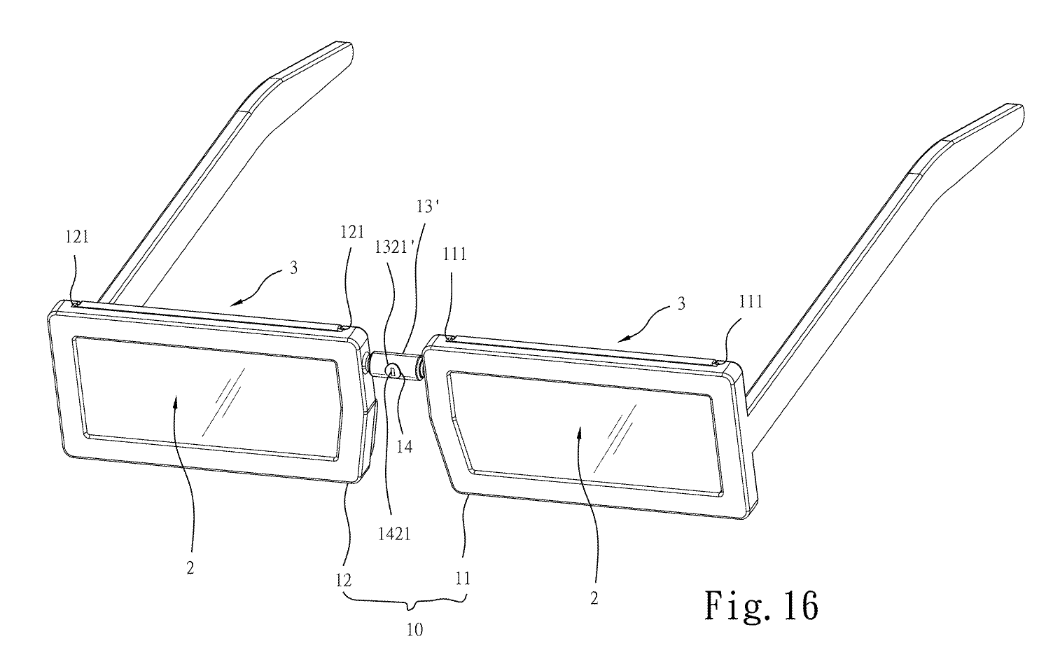

### DETAILED DESCRIPTION OF THE INVENTION

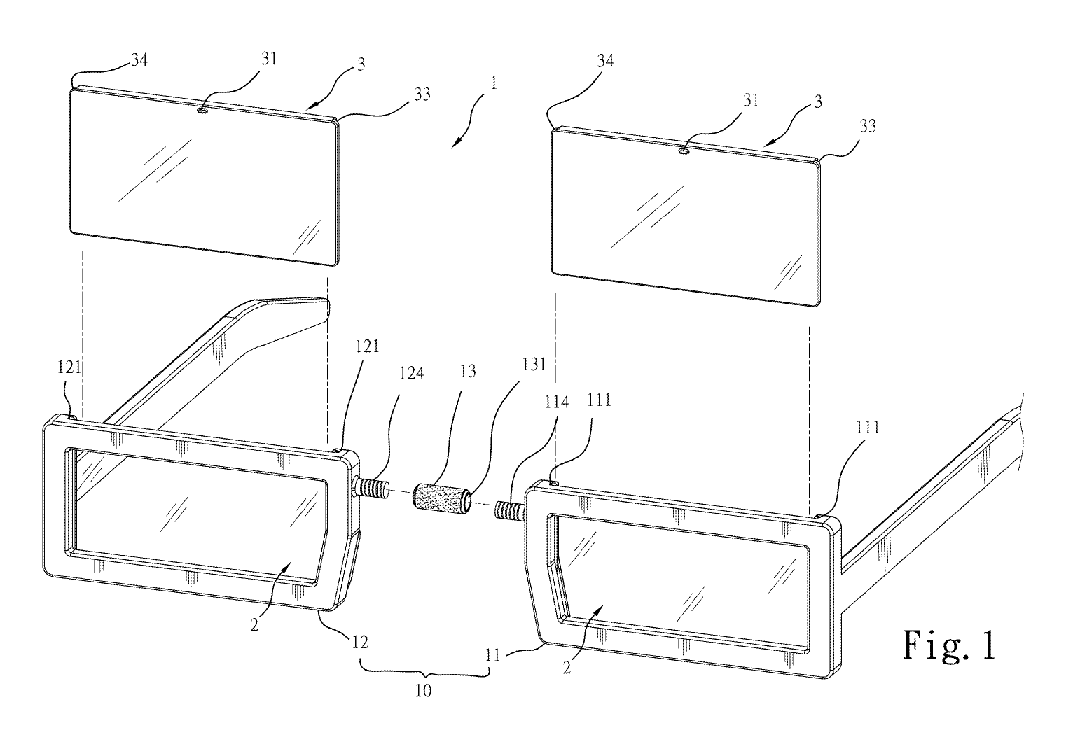

Referring to FIGS. 1˜8, a pair of 3D glasses 1 for 3D TV, 3D projector, 3D movie and 3D PC monitor in accordance with the present invention is shown comprising an eyeglass frame 10 having left and right rims 11;12, and a LCD 2 mounted in each of the left and right rims 11;12.

The main feature of the pair of 3D glasses 1 is outlined hereinafter.

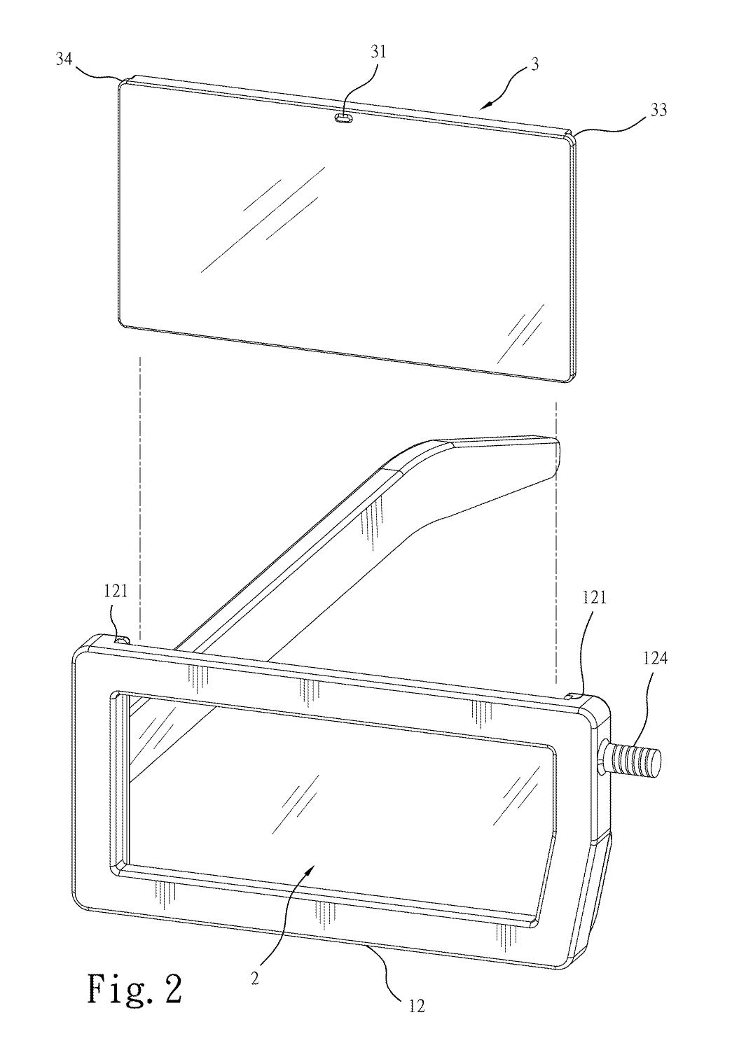

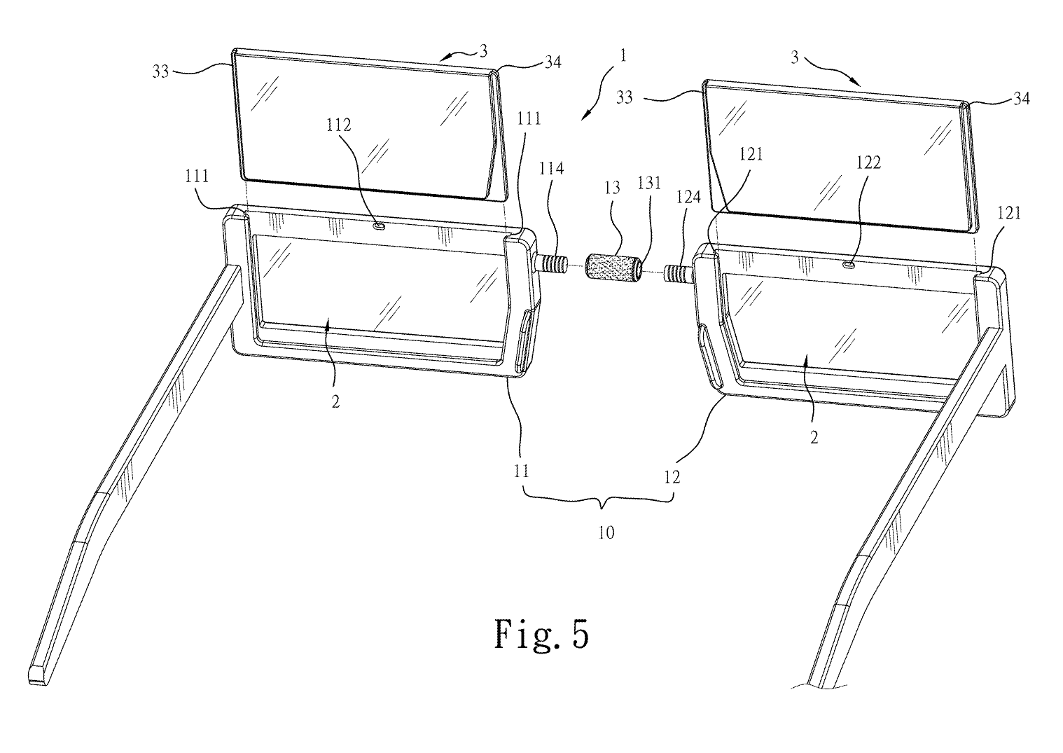

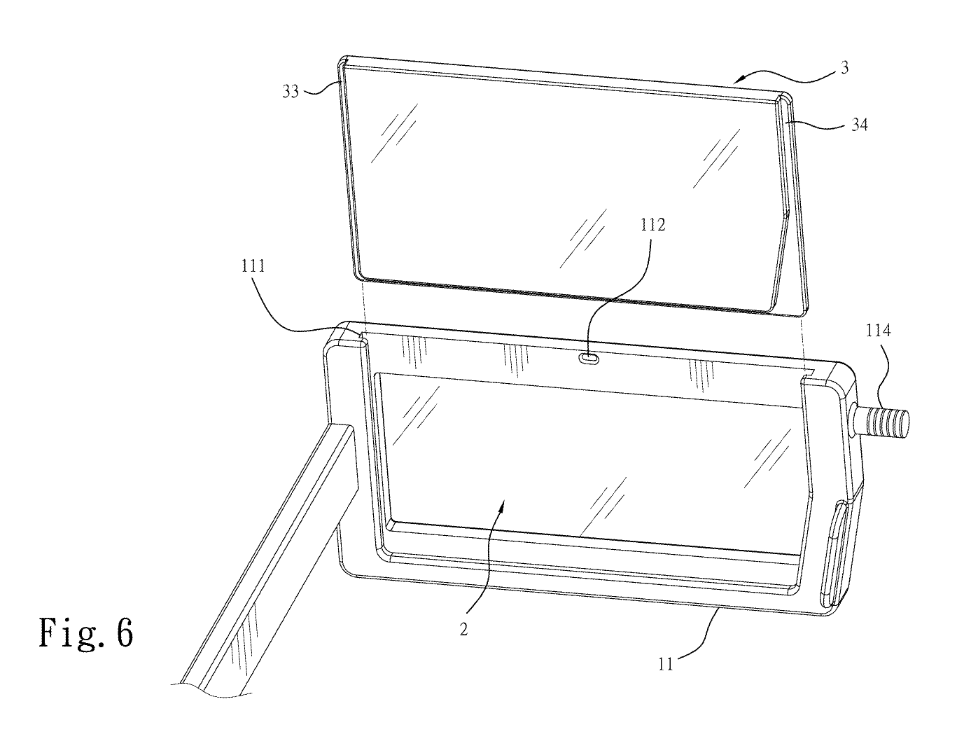

The left and right rims 11;12 of the eyeglass frame 10 each have a mounting groove 111;121. Left and right myopia lenses 3 are respectively mounted in the mounting grooves 111;121 of the left and right rims 11;12, and kept right behind the LCDs 2. The myopia lenses 3 are plastic lenses, each having a retaining block 31 (see FIGS. 1 and 2). The left and right rims 11;12 of the eyeglass frame 10 each have a retaining groove 112;122 corresponding to the retaining blocks 31 of the myopia lenses 3 (see FIGS. 5 and 6). After insertion of the left and right myopia lenses 3 into the mounting grooves 111;121 of the left and right rims 11;12, the retaining blocks 31 of the myopia lenses 3 are respectively engaged into the retaining grooves 112;122 of the left and right rims 11;12 respectively.

Subject to the aforesaid characteristics, the user can insert a respective myopia lens 3 into each of the mounting grooves 111;121 of the left and right rims 11;12 subject to the desired degree of short-sight. Thus, the user can wear the pair of 3D glasses 1 comfortably without using his (her) short-sighted glasses.

The eyeglass frame 10 further comprises an adjustment structure that allows adjustment of the pitch between the left and right rims 11;12. The adjustment structure comprises:

two screw rods 114;124 respectively located on the left and right rims 11;12 at an inner lateral side and aimed at each other, and

a bridge 13 that has a threaded hole 131 into which the two screw rods 114;124 are respectively threaded from two opposing sides.

Subject to the aforesaid structure, the user can rotate the bridge 13 to adjust the pitch between the left and right rims 11;12 so that the myopia lenses 3 can fit the user's eyes accurately and comfortably when watching a 3D TV program.

Further, the left and right myopia lenses 3 each have left and right mounting flanges 33;34 fitting the configuration of the retaining grooves 112;122 of the left and right rims 11;12 of the eyeglass frame 10 for positive positioning.

Further, the left and right myopia lenses 3 are available in −1.5, −1.6, −1.7, −1.8, −1.9, −2, −3, −4, −5, −6, −7, −8, −9 and −10 for selection and for installation in the retaining grooves 112;122 of the left and right rims 11;12 of the eyeglass frame 10.

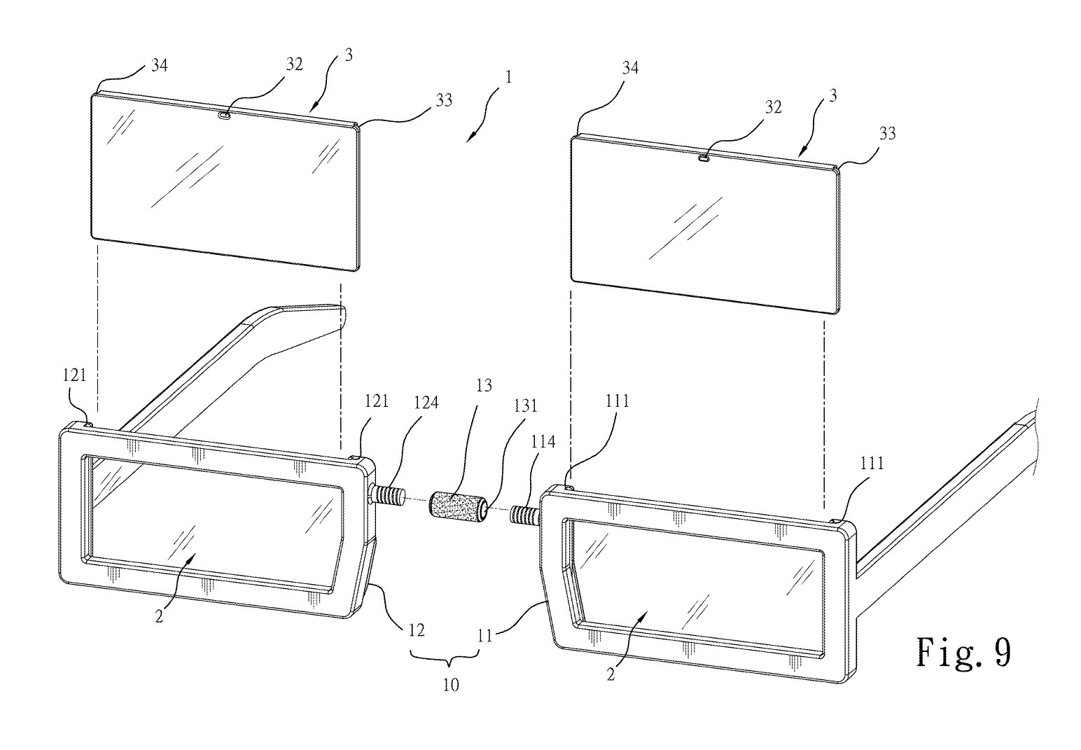

FIGS. 9˜12 show a pair of 3D glasses in accordance with a second embodiment. This second embodiment is substantially similar to the aforesaid first embodiment with the exception that the left and right myopia lenses 3 each have a retaining groove 32; the left and right rims 11;12 of the eyeglass frame 10 each have a retaining block 113;123 for engaging the retaining grooves 32 of the left and right myopia lenses 3.

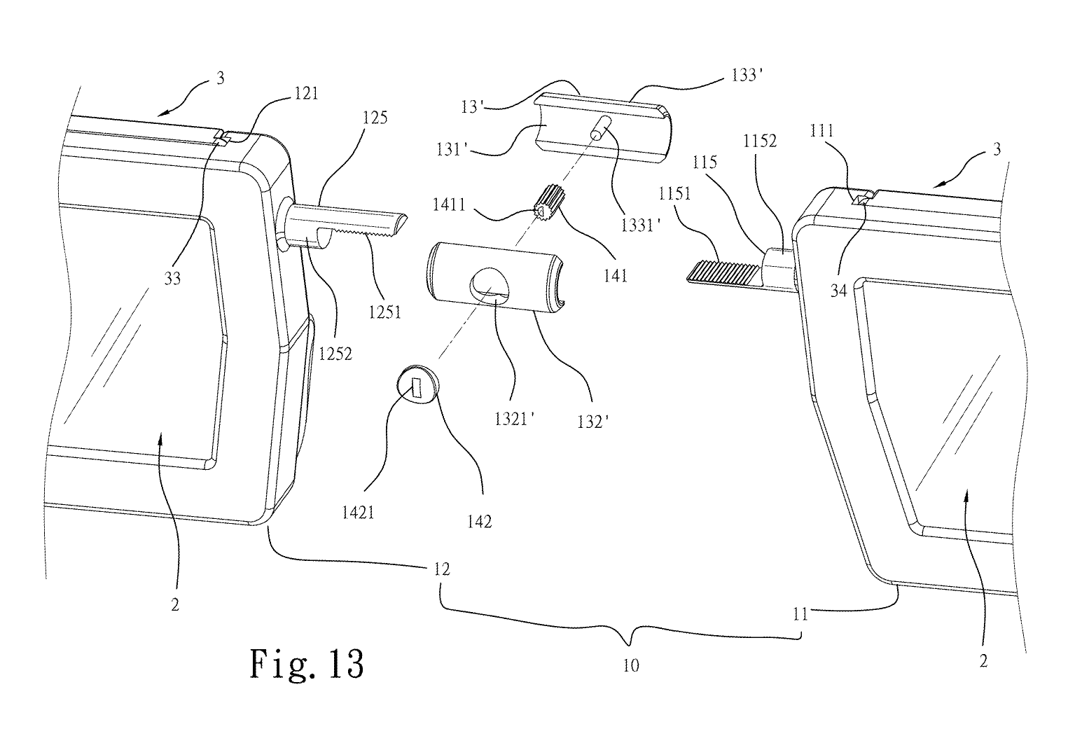

FIGS. 13˜16 show a pair of 3D glasses in accordance with a third embodiment. This third embodiment is substantially similar to the aforesaid first embodiment. According to this third embodiment, the left and right rims 11;12 of the eyeglass frame 10 each have a mounting groove 111;121; left and right myopia lenses 3 are respectively mounted in the mounting grooves 111;121 of the left and right rims 11;12, and kept right behind the LCDs 2. The myopia lenses 3 are plastic lenses, each having a retaining block (not shown). The left and right rims 11;12 of the eyeglass frame 10 each have a retaining groove (not shown) corresponding to the retaining blocks of the myopia lenses 3. After insertion of the left and right myopia lenses 3 into the mounting grooves 111;121 of the left and right rims 11;12, the retaining blocks of the myopia lenses 3 are respectively engaged into the retaining grooves of the left and right rims 11;12 respectively.

The eyeglass frame 10 of this third embodiment further comprises an adjustment structure that allows adjustment of the pitch between the left and right rims 11;12. The adjustment structure comprises:

two shafts 115;125 respectively located on the left and right rims 11;12 at an inner lateral side and aimed at each other, each shaft 115;125 having a toothed bar 1151;1251 axially extended from the distal end thereof;

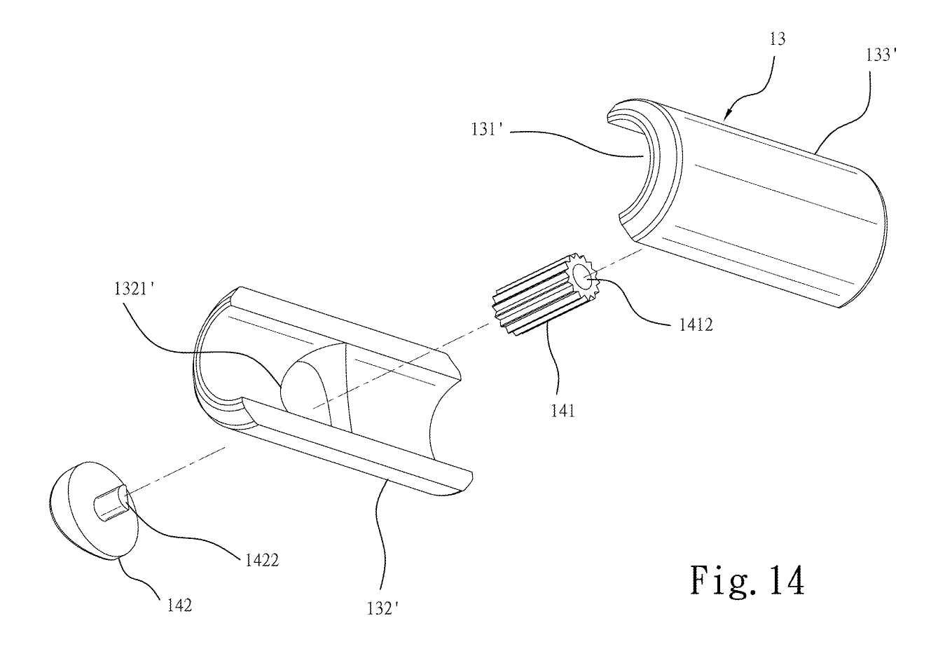

a bridge 13′ formed of two half shells 132′;133′ and defining an axle hole 131′ for receiving the two shafts 115;125, one half shell 132′ having a through hole 1321′ located on the middle and extending in a perpendicular direction relative to the axle hole 131′, the other half shell 133′ having a pivot pin 1331′ perpendicularly extended from the inside wall thereof corresponding to the through hole 1321′; and an adjustment device 14, which comprises a gear 141, which is meshed between the toothed bars 1151;1251 of the shafts 115;125 and has a mounting hole 1411 (see FIG. 13) located on one end thereof and a pivot hole 1412 located on the other end thereof and pivotally coupled to the pivot pin 1331′ (see FIG. 13), and an adjustment knob 142, which has a mounting rod 1422 perpendicularly extended from the back side thereof (see FIG. 14) and fastened to the mounting hole 1411 of the gear 141.

Further, as an alternate form of this third embodiment, the gear 141 and the adjustment knob 142 can be fastened together by means of a plug joint.

Further, as another alternate form of this third embodiment, the gear 141 and the adjustment knob 142 can be fastened together by means of a screw joint.

When rotating the adjustment knob 142 clockwise or counter-clockwise, the gear 141 is rotated to move the toothed bars 1151;1251 of the shafts 115;125 toward or away from each other, thereby changing the combined length of the shafts 115;125, i.e., changing the pitch between the left and right rims 11;12 of the eyeglass frame 10. Thus, the myopia lenses 3 can fit the user's eyes accurately and comfortably when watching a 3D program.

Further, the diameter of the root portions 1152;1252 of the shafts 115;125 is slightly smaller than the inner diameter of the axle hole 131′ of the bridge 13′, so that the shafts 115;125 can be moved in and out of the axle hole 131′ of the bridge 13′.

Further, the adjustment knob 142 of the adjustment device 14 has a tool groove 1421 located on the front side for the positioning of a hand tool for rotating the adjustment knob 142. The tool groove 1421 can be a keystone groove, Phillips groove, hexagonal groove, polygonal groove or socket groove for the positioning of a respective hand tool.

In conclusion, the invention has the following advantages:

1. The left and right rims 11;12 of the eyeglass frame 10 each have a mounting groove 111;121 so that a user can insert left and right myopia lenses 3 in the mounting grooves 111;121 of the left and right rims 11;12. Thus, the user can wear the pair of 3D glasses 1 to watch a 3D TV, 3D projector, 3D movie and 3D PC monitor program comfortably without using his (her) short-sighted glasses.

2. A different user can install left and right myopia lenses 3 in the mounting grooves 111;121 of the left and right rims 11;12 subject to the desired degrees of short sight.

3. The user can adjust the pitch between the left and right rims 11;12 to fit the eyes accurately and comfortably when watching a 3D TV, 3D projector, 3D movie and 3D PC monitor program.

What is claimed is:

1. A pair of 3D glasses, comprising an eyeglass frame, said eyeglass frame comprising left and right rims, and a LCD mounted in each of said left and right rims, wherein said left and right rims of said eyeglass frame each have a mounting groove; left and right myopia lenses are respectively mounted in the mounting grooves of said left and right rims and kept right behind the LCDs in said left and right rims.

2. The pair of 3D glasses as claimed in claim 1, wherein said left and right myopia lenses each have left and right mounting flanges respectively engaged into the retaining grooves of said left and right rims of said eyeglass frame.

3. The pair of 3D glasses as claimed in claim 1, wherein said left and right myopia lenses are plastic lenses, each having a retaining block; said left and right rims of said eyeglass frame each have a retaining groove adapted for receiving to the retaining blocks of said left and right myopia lenses.

4. The pair of 3D glasses as claimed in claim 1, wherein said left and right myopia lenses are plastic lenses, each having a retaining groove; said left and right rims of said eyeglass frame each have a retaining block respectively engaged into the retaining grooves of said left and right myopia lenses.

5. The pair of 3D glasses as claimed in claim 1, further comprising an adjustment structure adapted for adjustment of the pitch between said left and right rims, said adjustment structure comprising two screw rods respectively located on said left and right rims at an inner lateral side and aimed at each other, and a bridge connected between said two screw rods and rotatable to adjust the pitch between said left and right rims, said bridge having a threaded hole into which said two screw rods are respectively threaded from two opposing sides.

6. The pair of 3D glasses as claimed in claim 1, further comprising an adjustment structure adapted for adjustment of the pitch between said left and right rims, said adjustment structure comprising:
two shafts respectively located on said left and right rims at an inner lateral side and aimed at each other, each said shaft having a toothed bar axially extended from the distal end thereof;
a bridge, said bridge comprising a first half shell and a second half shell fastened together and defining therein an axle hole for receiving said two shafts, said first half shell having a through hole located on a middle part thereof and extending in a perpendicular direction relative to said axle hole, said second half shell having a pivot pin perpendicularly extended from an inside wall thereof corresponding to the through hole of said first half shell; and
an adjustment device, said adjustment device comprising a gear meshed between the toothed bars of said shafts, said gear having a mounting hole located on one end thereof and a pivot hole located on an opposite end thereof and pivotally coupled to the pivot pin of said second half shell, and an adjustment knob, said adjustment knob having a mounting rod perpendicularly extended from a back side thereof and fastened to the mounting hole of said gear.

7. The pair of 3D glasses as claimed in claim 6, wherein each said shaft having a root portion connected to the associating rim of said eyeglass frame, the diameter of the root portions of said shafts being smaller than the inner diameter of said axle hole of said bridge.

8. The pair of 3D glasses as claimed in claim 6, wherein said adjustment structure further comprising a plug joint adapted to secure said gear and said adjustment knob together.

9. The pair of 3D glasses as claimed in claim 6, wherein said adjustment structure further comprising a screw joint adapted to secure said gear and said adjustment knob together.
